(19) United States
(12) Patent Application Publication
(10) Pub. No.: US 2005/0156421 A1
(43) Pub. Date: Jul. 21, 2005

(54) Knee impact guard for motor vehicles

(75) Inventors: Thomas Nykiel, Oberteuringen (DE); Thomas Schmid, Gaertringen (DE); Andreas Sigloch, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/013,325

(22) Filed: Dec. 17, 2004

(30) Foreign Application Priority Data
Dec. 20, 2003 (DE) 103 60 124.4-22

(51) Int. Cl. B60R 21/045

(52) U.S. Cl. 280/752

(57) ABSTRACT

A knee impact guard for a motor vehicle includes an energy-absorbing foam section, a supporting element, and projections and recesses. The energy-absorbing foam section can be arranged substantially across a longitudinal axis of the motor vehicle. The supporting element is fastenable to the body structure of the motor vehicle, and the energy-absorbing foam section is held on the supporting element. The foam section and the supporting element are assembled with one another by the projections and the recesses complementary to and confronting one another.

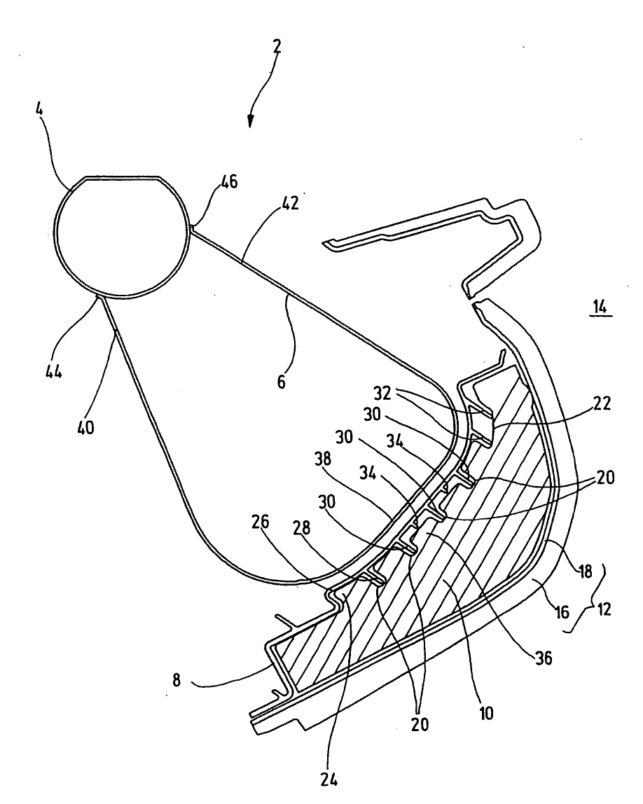

This application claims the priority of German Patent Document No. 103 60 124.4-22, filed Dec. 20, 2003, the disclosure of which is expressly incorporated by reference herein.

### BACKGROUND AND SUMMARY OF THE INVENTION

The invention relates to a knee impact guard for a motor vehicle, which guard has an energy-absorbing foam section that can be arranged substantially athwart the longitudinal axis of the motor vehicle and is mounted in a supporting element, the supporting element being attachable to the body structure of the motor vehicle.

A chief aim in the development of a new motor vehicle is the improvement of active and passive safety. Development engineers are oriented toward the state of the art and the requirements of law which apply to motor vehicles in various states. Due to special requirements which apply only in a few countries, it may be necessary to devote special attention to certain safety aspects. For example, a crash test is provided for motor vehicles in the United States of America, in which the occupants are not belted. In this case, it is important to protect the area of the knees of a vehicle occupant who in the event of a frontal or offset collision is accelerated forward relative to the vehicle. Of course, an optically adapted knee protection for conditions in the U.S.A. will have great advantages also in the rest of the world, especially when the occupants of a vehicle are not belted in spite of their legal obligations.

In the development of knee impact safety systems, two lines of development are followed. A first line of development provides that, in the area of the knees of vehicle occupants, relatively hard impact elements are provided. These direct the energy input from the knee of an occupant to a deformable support structure ahead of him. Such a supporting structure can be in the form, for example, of a loop. Such a design is disclosed in DE 195 11 512 C2.

The supporting structure can also be in the form of a honeycomb structure, the honeycomb structure being able by deformation to absorb collision energy. Such a design is disclosed in EP 0 678 425 B1. A disadvantage in these two designs is that the development, manufacture and adaptation of the support designs to certain types of motor vehicles is very expensive. The support designs are usually composed of sheet metal parts which require expensive tooling for large series production. Any final dimensions of the individual components of the support designs can be arrived at only after tedious and expensive crash tests.

A second line of development provides that the energy absorption is performed by energy-absorbing elements which are arranged in the area of a motor vehicle in front of the knees of an occupant. In the simplest case a one-piece foam product can be used, which extends virtually over the entire width of the driver side of a motor vehicle. Such a device is disclosed in U.S. Pat. No. 3,897,848. Improved embodiments have multipartite foam part designs which are proposed in DE 36 11 486 C2 and in DE 198 10 481 A1.

The designs disclosed in the last-named patents provide a bulky foam part which is affixed to a mounting bracket with a plastic dowel. A disadvantage in this design is that, in case of a crash, the foam part can come loose from the mounting bracket and accordingly is able to absorb no or only a small amount of energy.

Setting out from this, the present invention is addressed to a problem of creating a knee impact guard for motor vehicles which can be manufactured economically, can absorb great amounts of energy and is especially reliable.

This problem is solved according to the invention in that the foam section and the supporting element are mounted on one another by projections and recesses complementary to one another and confronting one another. By this measure the foam section and the supporting element can be combined conformably with one another, so that in the event of a crash any movement relative to one another is prevented. The term, “conformably with one another,” is intended to mean that projections and recesses are so configured that the relative position of supporting element and foam section is defined. Thus the foam section can have projections which engage in recesses that are formed on the supporting element. In this way the supporting element can have projections which engage in recesses in the foam section. A combination of these two possibilities is also conceivable. Furthermore, in no way is it necessary that the foam section be held without free play on the supporting element. Considering the fact that the foam section can be a floppy component if the foam section is relatively soft, it may be advantage for the recesses to be made slightly larger than the complementary projections. In such a case the assembly of the foam section on the support is made easier. However, it must be taken into account that, in case of a crash, the foam section may shift too far away or lift off of its supporting element.

It is especially advantageous if the supporting element has projections n the form of ribs which engage in recesses formed in the foam section. This configuration has the advantage that the projections of the foam section can be made relatively bulky, so that the foam section will be held well on the supporting element without the danger that the projections of the foam section might shear off.

The projections and recesses can be elongated in shape and especially may be arranged substantially transversely across the long axis of the motor vehicle. Thus the foam section can be mounted face-to-face against the supporting element and the pressure and thrust forces can be introduced uniformly into the foam section and the supporting element. In this way the danger is avoided that in the event of a crash the foam section might fail in a relatively small area before its energy-absorbing capacity of the entire foam section is exhausted.

The supporting element can be in the form of a structural shape and can be manufactured in the extrusion process, for example. Thus the supporting element with the projections and/or ribs formed can be manufactured at reasonable cost. This element can furthermore be easily adapted to different vehicle widths.

The supporting element is preferably formed from light metal, especially aluminum and/or magnesium. The knee impact protector can thus be made relatively light, which contributes toward an overall low vehicle weight. Moreover, it can be brought about in this manner that the supporting element and especially the projections and/or recesses of the supporting element can be deformed, so that in addition to energy absorption by the foam section energy can be absorbed by the deformation of the supporting element.

The supporting element and the foam section can be assembled together through additional means. Advantageously, the means are in the form of spurs and/or projections which penetrate locally into the foam section. This signifies that in the area of the spurs and/or projections which face the foam section no recesses are provided into which the spurs and/or projections are received. Instead, the spurs and/or projections penetrate into the material of the foam section in order to produce a fixation of the foam section on the supporting element.

Preferably the supporting element can be joined to a cross member of the motor vehicle. In this way the forces introduced into the knee impact guard can be introduced into the body structure of the motor vehicle. The fastening to the cross member of the motor vehicle or generally to the body structure of the motor vehicle can be accomplished with a dish-shaped holder, which is joined to the body structure at one end and to the supporting element at the other end. In this way any space that may be present, for example between the cross member and the supporting element, can be spanned, and on the other hand an additional element is created which is able in case of a crash to absorb energy.

The foam section can have a cover on the side facing away from the supporting element. This cover is facing the occupants of the vehicle and makes it possible to adapt the knee impact protective element to the design of the vehicle's interior.

The invention also relates to a method for energy absorption in case the knee of an occupant collides with vehicle parts in front of the knee. Then, in a first absorption phase a foam section is deformed which is substantially perpendicular to the long axis of the motor vehicle and is mounted on a supporting element. In a second absorption phase, projections and/or recesses complementary to one another and facing one another, by which the supporting element and the foam section are joined together, are deformed. By this multi-stage energy absorption an optimum protection of the occupants of the vehicle is achieved.

This energy absorption can be followed by additional absorption phases. For example, the supporting element itself can deform. After this, directly following the second absorption phase, a holder by which the supporting element is joined to the body structure of the vehicle can also become deformed. Thus the protection of the knees of the vehicle's occupants is further optimized.

Additional advantageous embodiments and details of the invention are to be found in the following description wherein the invention is further described and explained with the aid of the embodiment represented in the drawing.

Other objects, advantages and novel features of the present invention will become apparent from the following detailed description of the invention when considered in conjunction with the accompanying drawings.

### BRIEF DESCRIPTION OF THE DRAWINGS

The drawing shows in a side elevation a section of a knee impact guard generally identified by reference numbers. The knee impact guard 2 comprise a tubular cross member 4 which extends between the A columns of a motor vehicle not further represented. A dish-shaped holder 6 is fastened to the cross member 4, and it is joined by means not further represented to a supporting element 8 on which a foam section 10 is mounted on the side remote from the holder 6. The foam section 10 has on the side remote from the supporting element 8 a cover 12 which faces the interior 14 of the vehicle.

The cover comprises an outer layer 16 which can be shaped for ease in handling the cover 12. The outer layer 16 of the cover 12 adjoins an inner layer 18 which forms a support layer for the outer layer 16.

The foam section 10 arranged between the supporting element 8 and the cover 12 has narrow recesses 20 and one wide recess 22 on the side facing the supporting element. Furthermore, adjacent to the recess 20 that is lowermost in the drawing a projection 24 of the foam section 10 is provided. The recesses 20 and 22 as well as the projection 24 are elongated and run transversely across the length of the motor vehicle that is not represented.

The supporting element 8 has a recess 26 in which the projection 24 of foam section 10 is received. The recess 26 of the supporting element 8 is defined in sections by a rib-like projection 28 which engages in the lowermost recess 20 of the foam section 10. In like manner, additional rib-like projections 30 parallel to the rib-like projection 28 are provided, which are received in the recesses 20 of the foam section 10.

The supporting element 8 has at its upper end in the drawing two additional rib-like projections 32 which are held together in the recess 22 formed in the foam section 10. Both the recess 26 and the projections 28, 30 and 32 are elongated and like the projection 24 and recesses 20 and 22 of the foam section they run transversely of the length of the vehicle. By means of the recesses 20, 22 and 26, which cooperate with corresponding projections 24, 28, 30 and 32, the foam section 10 can be reliably mounted on the supporting element 8. In case of a collision, it is possible thus to prevent the foam section 10 from separating from the supporting element 8 or shift with respect to it by an unwanted amount.

The supporting element 8 furthermore has two elongated sections 34 disposed between the projections 30. These sections are facing the foam section 10 and penetrate into material sections 36 of the foam section 10. In this way too, the foam section 10 can be mounted reliably on the supporting element 8.

The supporting element 8 is joined on the side away from the foam section 10 to a bottom section 38 of the holder 6. The bottom section 38 of the holder 6 merges on both sides with side portions 40 and 42 which are fastened through connecting sections 44 and 46 to the cross member 4 of the motor vehicle.

In case of a crash, the knees of a vehicle occupant in the interior 14 of the vehicle collide with the cover 12. In this case the energy is first absorbed by the foam section 10. If the energy absorbing capacity of the foam section 10 should not be sufficient, a deformation of the projections 24, 28, 30 and 32 and of recesses 20, 22 and 26 can occur in a subsequent absorption phase. In an additional absorption phase the supporting element 8, together with the holder 6 in some cases, can be deformed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A knee impact guard for a motor vehicle having a body structure, comprising:
an energy-absorbing foam section which can be arranged substantially across a longitudinal axis of the motor vehicle;
a supporting element fastenable to the body structure of the motor vehicle, wherein the energy-absorbing foam section is held on the supporting element; and
projections and recesses, wherein the foam section and the supporting element are assembled with one another by the projections and the recesses complementary to and confronting one another.

2. The knee impact guard according to claim 1, wherein the supporting element has projections configured as ribs which engage in recesses formed in the foam section.

3. The knee impact guard according to claim 2, wherein the projections and recesses are of elongated shape.

4. The knee impact guard according to claim 3, wherein the projections and recesses can be arranged substantially transversely across the longitudinal axis of the motor vehicle.

5. The knee impact guard according to claim 4, wherein the supporting element is configured as a profile element.

6. The knee impact guard according to claim 5, wherein the supporting element is formed from one of aluminum and magnesium.

7. The knee impact guard according to claim 6, wherein the projections and/or the recesses are deformable.

8. The knee impact guard according to claim 7, wherein the supporting element and the foam section are assembled to one another through additional fixation devices.

9. The knee impact guard according to claim 8, wherein the fixation devices are formed by protrusions which penetrate locally into the foam section.

10. The knee impact guard according to claim 9, wherein the supporting element can be joined to a cross member of the motor vehicle.

11. The knee impact guard according to claim 10, further comprising a dish-shaped holder by which the supporting element can be joined to the body structure of the motor vehicle.

12. The knee impact guard according to claim 11, wherein the foam section has a cover on a side remote from the supporting element.

13. A method for energy absorption in case of a collision of a knee of a motor vehicle occupant against a part of a motor vehicle which is in front of the knee, comprising:
in a first absorption phase, deforming a foam section which is arranged substantially across a long axis of the motor vehicle, and is mounted on a supporting element, the supporting element being joined to a body structure of the motor vehicle; and
in a second absorption phase, deforming projections and/or recesses complementary to and facing one another, through which the supporting element and the foam section are assembled together.

14. The method according to claim 13, further comprising: in an absorption phase deforming the supporting element.

15. The method according to claim 14, wherein in the absorption phase further deforming a holder, by which the supporting element is joined to the body structure of the motor vehicle.
